(19) United States
(12) Patent Application Publication
(10) Pub. No.: US 2005/0167343 A1
(43) Pub. Date: Aug. 4, 2005

(54) Apparatus for sorting

(76) Inventor: Igal Avishay, Holon (IL)

Correspondence Address: IGAL AVISHAY, 17 ZVI SHATZ STREET, HOLON, IL

(21) Appl. No.: 10/912,139

(22) Filed: Aug. 6, 2004

(30) Foreign Application Priority Data
Jan. 29, 2004 (IL) 160119

(51) Int. Cl. B65H 39/10; B07C 5/00; G06K 9/00

(52) U.S. Cl. 209/584

(57) ABSTRACT

Apparatus for sorting mail, comprising a frame with vertical partitions and a number of removable drawers between the partitions. Every drawer has an aperture on its upper part in a manner which allows to insert mail envelopes into the drawers by the sorting employee. The frame includes vertical cells, each cell having a narrow front and a wider back, with partitions for creating cells in one or more rows being installed therebetween, with drawers removable from the top of each cell.

### CROSS-REFERENCE TO RELATED APPLICATIONS

The present application claims priority from a patent application filed in Israel on 29 Jan. 2004 by the present applicant, application No. 160119 entitled “Apparatus for sorting”.

### FIELD OF THE INVENTION

This invention relates to a mechanical, manual apparatus for sorting objects, and more specifically to an apparatus with drawers for sorting mail, into cells having a generally vertical orientation.

### BACKGROUND OF THE INVENTION

A widely used method for sorting mail uses mailboxes—for example sorting mail addressed to different people in a office, or for different departments in the enterprise. The boxes are usually attached to the wall.

The mailbox system presently in use has various disadvantages, including for example:

a. In sorting mail into boxes, the inner space of the boxes is intended to receive packages, envelopes and papers. Therefore the boxes need to be large and thus take a large area. Most of the time, the available space in the boxes is unused. This is a waste of expensive space in the office.

b. When there is a large quantity of large boxes, they take a large area. The employee sorting the mail into the boxes has to stand up and bend during sorting, and also to walk from one side of the mailboxes array to the other side and back. This causes the employee to become tired and it is a waste of time in the process of sorting the mail.

c. The boxes are usually attached to the wall and are far from the desk. This requires more time to reach the boxes, wherein the employee has to stand up and walk from his/her desk to the mail boxes and back.

d. Boxes attached to the wall cause a waste of expensive wall area, an area which can be used for office cabinets for example. On the other hand, it is not practical to put a large apparatus with big boxes in the middle of the office.

e. The boxes have a fixed volume which cannot be changed. If the boxes are large, most of the boxes' volume is not used, thus wasting space in the office. Large boxes meaning here boxes which are larger than the average of the size of mail which is expected to arrive. If the boxes are smaller than the average, there may not be enough space in the boxes for mail.

f. When the mailboxes are near the wall, the sorting work is done with one hand, because the employee is using the second hand to carry the mail to be sorted, this being inefficient and exhausting for the employee.

g. At the end of the sorting, the mail should be taken out from the boxes and placed in envelopes, then one has to place directions on each envelope, specifying an address of a box. This process too takes much time.

Other Prior Art Methods for Sorting Mail:

1. Sorting mail into sacks. The method has similar disadvantages to the boxes method: the volume of the sacks is fixed and they are relatively far from each other.

This is not comfortable for work. Another disadvantage—papers in the sack get wrinkled and often get torn.

2. Mechanical/electrical installations for sorting mail. These are mainly mechanical systems, their majority operated with electricity.

They are complex and comprise a large number of parts, which require handling and maintenance. When there is a fault or the electricity supply breaks down, the sorting is halted.

These installations may not be practical for smaller offices, part of the reasons being that they are expensive and capture a large area.

### SUMMARY OF THE INVENTION

The current invention relates to an apparatus with drawers for sorting mail. The apparatus has a structure that allows to sort and store mail efficiently.

The apparatus is divided into three sorting areas: packages, envelopes and papers.

Therefore there is no need for large mailboxes, thus achieving a better usage of the volume of the boxes and saving a lot of space.

The distance between the boxes is shorter, thanks to the drawers that are narrow at their front and wider at their back.

Therefore, the employee can sort the mail while sitting comfortably, even if there is a large number of boxes.

Thus, using the invention can save time during sorting mail, many working hours in one example.

At the same time, the apparatus has a big capacity to contain mail, thanks to the drawers that are wider at their back and it is possible for the drawers to protrude out from the back side of the apparatus.

The apparatus may have small dimensions, thus allowing it to be placed on the desk. It is comfortable to work with, giving access to all the boxes, which are now within reach.

The employee can sort mail while sitting comfortably.

This new apparatus saves expensive area near the wall.

It is possible to change the bulk of the boxes in the apparatus, by a novel structure that allows using drawers with different volumes. The length of each drawer determines its inner volume (the capacity to hold mail).

It is possible to change the volume of each box separately, every day and every hour, without changing the volume of other boxes. It is possible to enlarge or to reduce the volume of each box, to adapt each box individually to the changing needs of each addressee.

It is possible to enlarge easily, with a number of seconds, the volume of each box. This is done by replacing a drawer with another drawer of a larger volume, into the same cell. It is necessary to shift the mail and the address ticket to a longer drawer, and to insert the larger drawer to a cell to replace the shorter drawer.

This method may be used to achieve both a saving of space and better usage of the volume of boxes.

In one preferred structure, at the front of the apparatus there is a shelf, upon which the mail for sorting is being placed. This frees both a user's hands for sorting mail into all directions, to achieve efficiency at work and comfort for the employee.

The drawers in the appartus can have a double use: to hold the mail during sorting, and also to be an instrument for mail distribution to addressee (for example departments of the company). This eliminates the need for envelopes for internal mail distribution.

This also achieves savings in time and work.

### BRIEF DESCRIPTION OF THE DRAWINGS

My invention will be described as follows by one practical example of the possible embodiments, together with reference to the drawings, in which:

FIG. 1 illustrates an isometric view of an apparatus for sorting mail and drawers which can be pulled out from the back

FIG. 2 illustrates a top view of the apparatus with an additional apparatus for packages

FIG. 3 describes a side view of the apparatus with an additional apparatus for packages

FIG. 4 details a drawer in a front, top and rear view

FIG. 5 describes an isometric view of an apparatus with more than one row of cells, each having a narrow front and a wider back

FIG. 6 details a drawer with a folding shelf for sorting papers.

FIG. 7 details a side view of an apparatus with an additional apparatus for packages at the back with drawers which can be pulled from the top

FIG. 8 describes an isometric look of an integrated apparatus

FIG. 9 details a top view of several units of a sorting apparatus, placed circularly around a turning chair

FIGS. 10, 11 describe isometric views of a double sided apparatus.

### DETAILED DESCRIPTION OF THE PREFERRED EMBODIMENTS

Examples of my invention will now be described, with reference to the enclosed drawings.

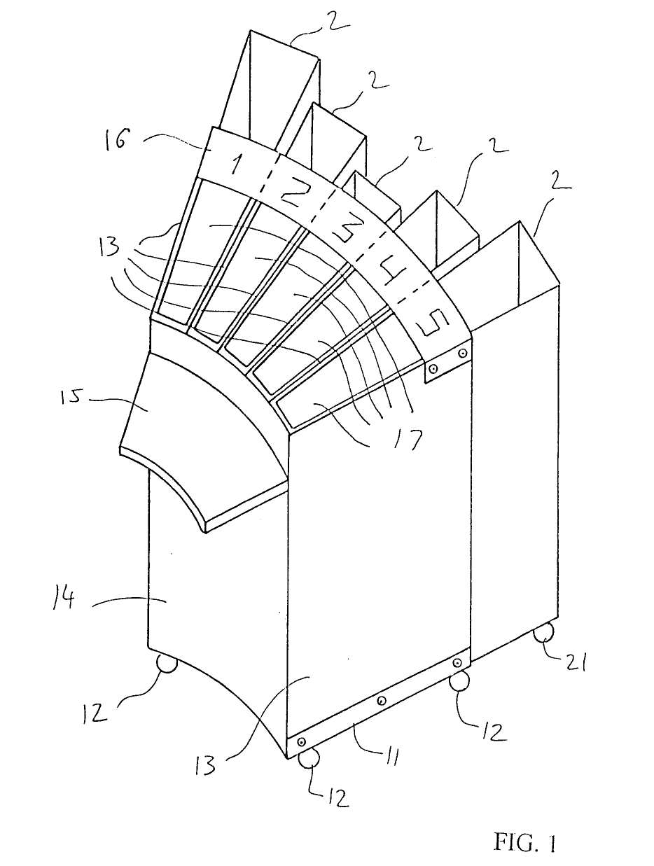

In one preferred embodiment, FIG. 1 describes an isometric view of an apparatus for sorting mail. The apparatus for sorting mail includes three sorting areas: packages, envelopes and papers.

The following disclosure details the area for sorting envelopes.

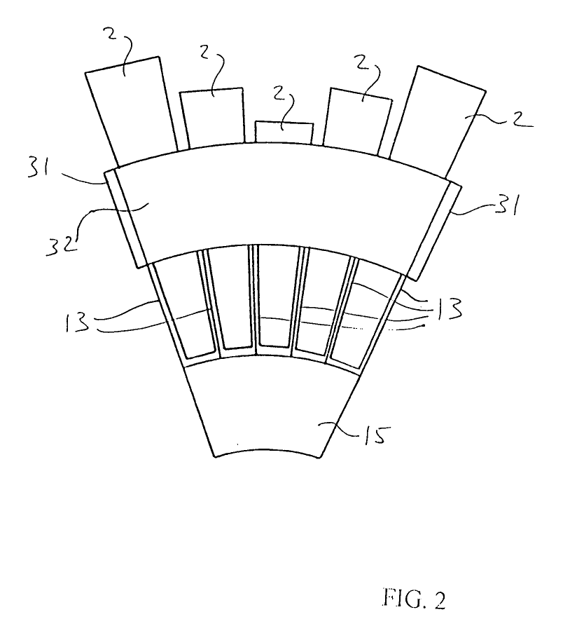

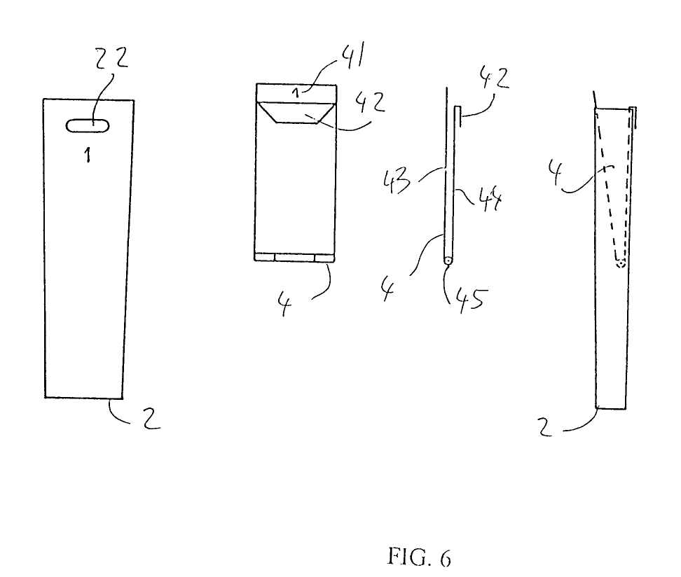

Sorting packages is detailed, for example, with reference to FIGS. 2, 3 and 7. Sorting papers is detailed, for example, with reference to FIG. 6.

The apparatus includes:

A base 11 on wheels 12, partitions 13, front of the apparatus 14, shelf for sorting mail 15. A wide strap 16 connects the partitions 13. It is possible to write on the strap 16 the addresses of the appropriate drawers.

The vertical partitions 13 create between them cells into which can be inserted the drawers 2, and openings 17 for inserting mail envelopes to drawers 2, respectively.

The apparatus comprises a base 11 which is placed on wheels 12, its front part is narrow and its back part is wide. On the base 11, the front of the apparatus 14 is placed perpendicularly, on its front side there is a shelf for mail to be sorted 15 and on its back side there are partitions 13 that create cells which are narrow on their front part and wide on their back part. It is possible to add a mail shelf for sorting 15 to the front apparatus at the front part.

A wide strap 16, is placed on the partitions 13, on their upper part, and ties them together, in order to maintain a fixed distance between them and for enhancing the stability of the apparatus. On the wide strap 16, the addresses of the boxes may be marked.

Drawers 2 may be inserted into the boxes from the back side of the apparatus.

FIG. 2 describes a top view of the apparatus with an addition of an apparatus for mail packages.

The apparatus includes partitions 13 and a shelf for sorting mail 15. Drawers 2 are inserted into the apparatus. It is possible to place packages on an apparatus that includes a frame 31 holding shelves 32.

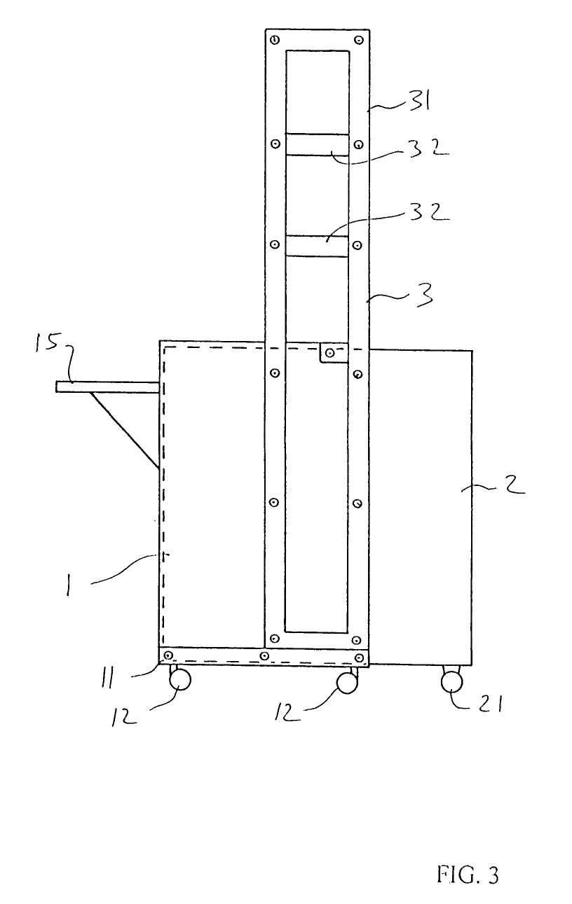

FIG. 3 illustrates a side view of an apparatus with an addition of apparatus for packages.

The apparatus for sorting mail 1 includes a base 11 on wheels 12 and a shelf for sorting mail 15. Similarly, drawers 2 on wheels 21 and an apparatus for packages 3, that includes a frame 31 that holds shelves 32, are included.

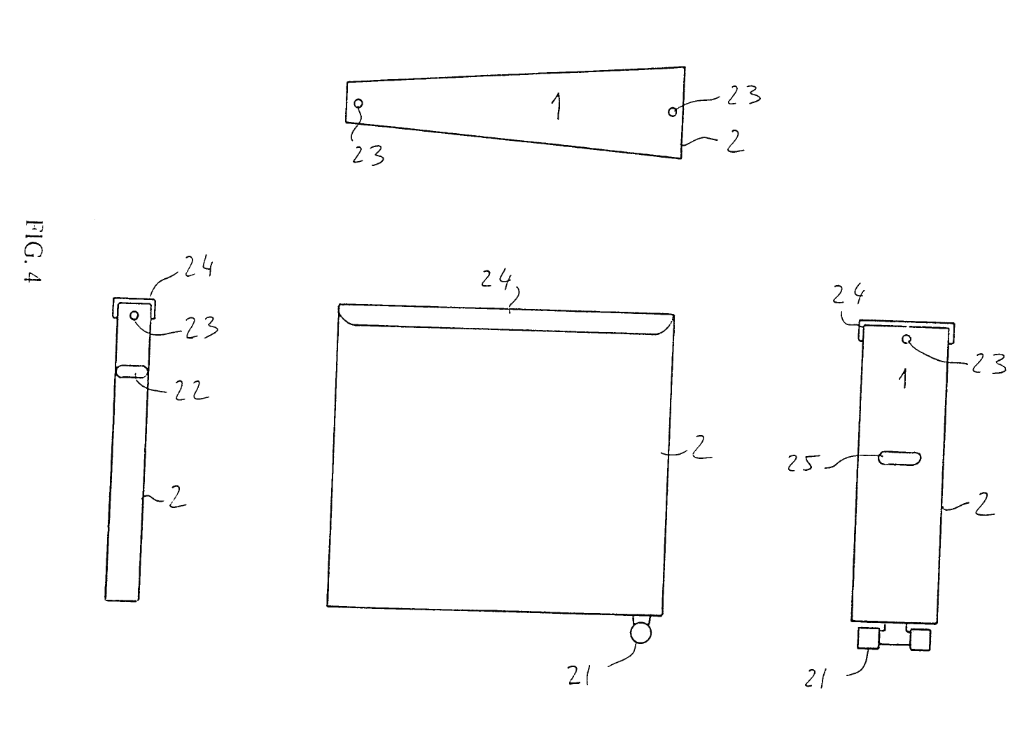

FIG. 4 details a drawer 2 on a front view (lower middle of the sheet), a top view of the cover 24 (upper middle), a view from front (left side) and from the back (right side).

The drawer 2 includes wheels 21 for easy rolling on the floor.

On front of drawer 2 there is a lifting opening 22, in order to drag the drawer 2 on the wheels 21, like a suitcase.

A cover 24 on the upper front of the drawer can be locked it in place, using a locking hole 23 in the upper part.

An opening 25 at the back part of drawer 2 may be used for pulling it.

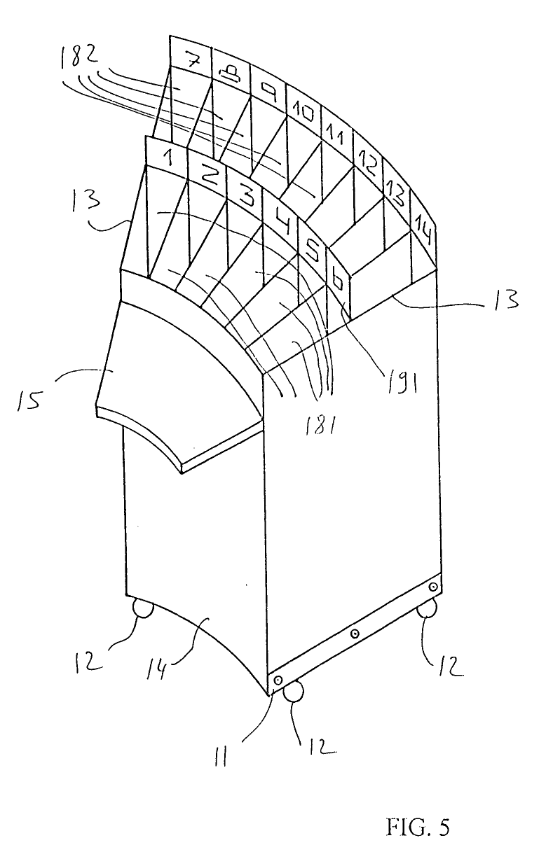

FIG. 5 describes an isometric view of the apparatus, comprising a narrow front and a wider back which are placed vertically on a base 11 that is placed on wheels 12. Between the front and the back of the apparatus, there are partitions which create one or more rows of cells.

Drawers are inserted into the cells from above. The drawers have dimensions adapted to those of the cells they are inserted therein.

The apparatus includes: a base 11 on wheels 12, partitions 13, the front of the apparatus 14, a shelf for sorting mail 15 and the back of the apparatus 192.

There is a first row of cells (front) 181 and a second row of cells (back) 182.

There is a middle partition 191 between the first row of cells 181 and the second row of cells 182. There is back 192, behind the second row of cells 182. The apparatus can include two rows of cells (as illustrated in this example) or more.

The upper part of the back of the apparatus 192, and the middle partition 191 between the lines are preferably protruding, and on them the addresses of the cells may be marked.

It is possible to add shelves to the back of the apparatus, for sorting packages. To each drawer it is possible to add a folding shelf for sorting papers.

FIG. 6 describes a drawer 2 (at the extreme left of the sheet), a foldable shelf for sorting papers 4 in a front view (second from left side), a foldable shelf for sorting papers 4 on a side view (third from left side), and a drawer 2 with a foldable shelf for sorting papers 4 installed in the drawer, a side view (extreme from right).

FIG. 6 details a drawer 2 with a foldable shelf for sorting papers, and a drawer 2 with a lifting opening and holding 22. The drawer 2 is narrower at its lower part, to facilitate its insertion into the apparatus.

The address of the box 41 is marked on the long part in the upper part and on clasp 42 on the short part.

The drawers 2 should have the appropriate dimensions for cells in height, width and length, while at their lower part they preferably are slightly narrow—so as to facilitate their insertion into, and their extraction from, the cells.

The drawers 2 have a holding aperture in order to take them out from the cells. They can be used as storing means for distributing mail to the departments or the addressees, saving the need for envelopes or sacks and eliminating the time required for transferring the mail into them.

Description of Preferred Embodiment of the Drawers 2

The drawers can have different length sizes, allowing to set a different volume to each box separately, according to specific needs.

As the drawers 2 are protruding out of the apparatus, it is possible to add wheels 21 at their backside. To a drawer with wheels it is possible to add a cover 24 with locking facilities and a lifting aperture at the front side for convenient dragging.

The drawer can be used as a locked suitcase, for transporting the mail to the branches, or external departments.

Saving in sacks which may be torn when dragging them is achieved, saving the need to replace them with new—a matter that may cause a considerable waste of money.

On the drawers it is possible to mark the cell address.

To each drawer 2 or partition it is possible to attach a folding shelf 4 for sorting papers.

The folding shelf comprises two parts: a long part 43 and a short part 44 that are connected therebetween at their lower part on axis 45.

The short part 44 is equipped with a clasp 42 at its upper part. On the long part at the upper part the address of the cell (box) is marked.

When there are many envelopes to be sorted, the shelf can be in its closed position, using a rubber band for example.

When there are many papers to be sorted, the shelf may be in its open position.

At the end of sorting, it is possible to close the shelf with the papers and to lay them in the drawer or in the sack, in order to prevent wrinkles or tearing of the papers.

The shelf can be made from one flexible part, at its closed position without axis.

Shelf for Sorting Mail

A shelf 15 is attached horizontally, at the front of the apparatus, its front part preferably being somewhat narrower.

On the shelf 15 the mail for sorting may be placed. This frees both of an employee's hands for sorting mail to all directions.

Shelves for Mail Packages

Another embodiment of the invention includes a sorting apparatus with a back, thus it is possible to attach shelves to packages and irregular mail.

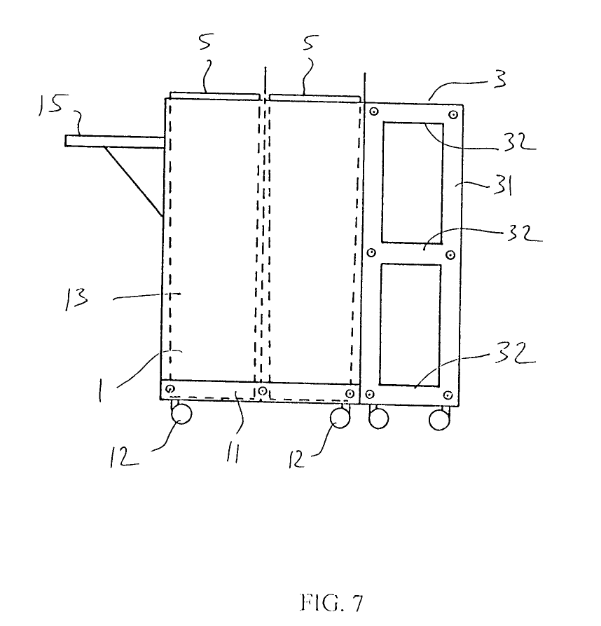

FIG. 7 details a side view of apparatus for sorting mail 1 with the addition of an apparatus for sorting packages 3 at the back. The apparatus includes a base 11 on wheels 12, partitions 13 and a shelf for sorting mail 15.

The drawers 5 are inserted from above into the apparatus 1.

The apparatus for packages 3 includes a frame 31 that holds shelves 32.

The packages can be laid according to the order of the cells.

The shelves for the packages 32 at the back of the apparatus contribute to the saving of area and to maximal usage of the volume of the cells (boxes), because it is possible to reduce their size to the required minimum.

The shelves for the packages 32 can be a separate part of the apparatus.

It is possible to add shelves for packages, to the apparatus wherein the drawers are inserted from the back. The shelves may include frames which are attached from both sides of the apparatus.

For an apparatus integrated with cells, into which drawers are inserted from above and from the back, it is possible to add shelves for packages in the same way.

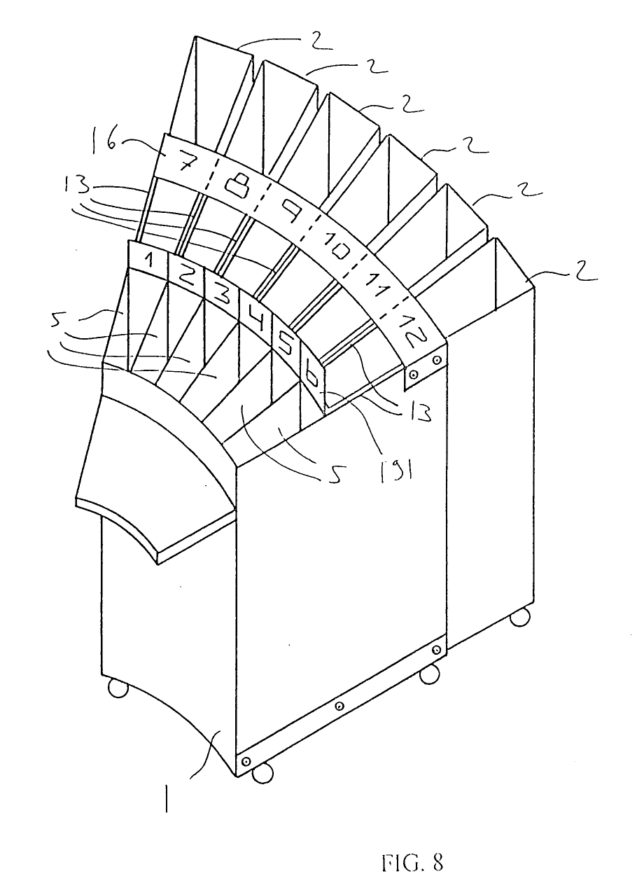

FIG. 8 details an isometric view of an integrated apparatus, which includes drawers 2 that are inserted from the back of the apparatus 1, and cells for drawers 5 that are inserted from above to the apparatus 1.

The apparatus also includes a middle partition 191, between the line of the cells 5 and the line of the drawers 2. Similarly, a wide strap 16 is included, which ties the partitions 13 together and also allows to write on the strap 16 the addresses of the cells.

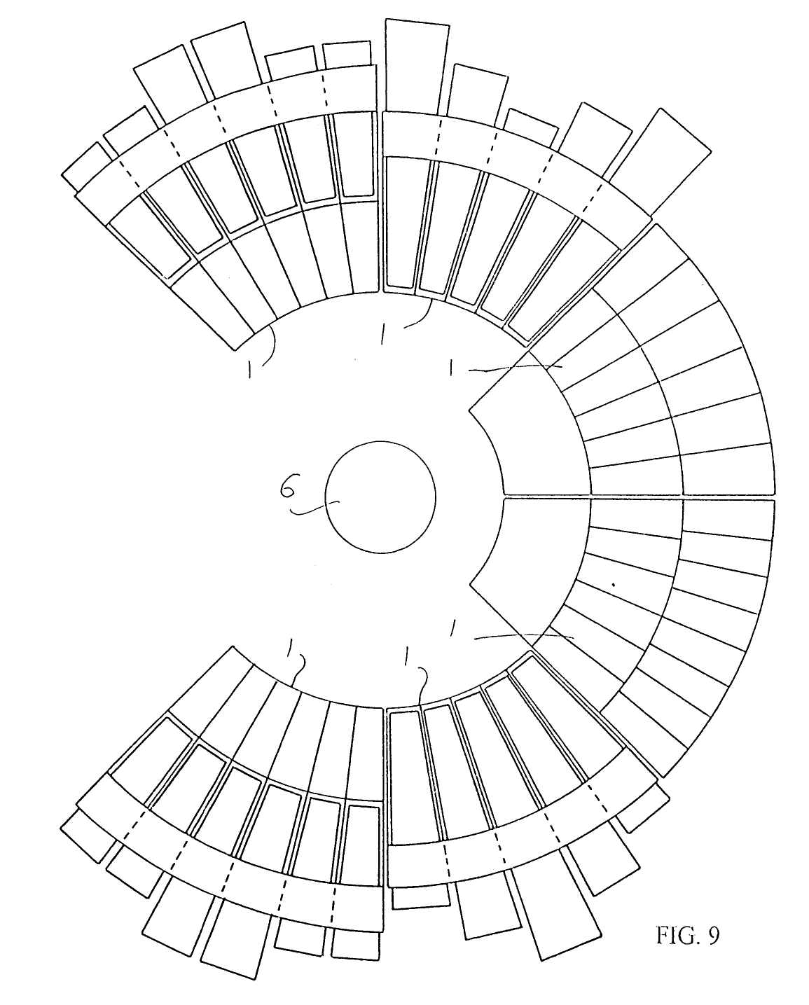

FIG. 9 details a top view of several units of a sorting apparatus 1, arranged in a circular arc about a turning chair 6. The shape of the apparatus is as described—an arc of a circle, with a smaller radius at the front of the apparatus and a larger radius at the back part—allowing convenient access for the operator/mail clerk to the different cells. It is possible to connect a number of units of the sorting apparatus 1 as detailed, to provide convenient access to a larger number of drawers and/or mail boxes, while the secretary is sitting comfortably on the chair 6.

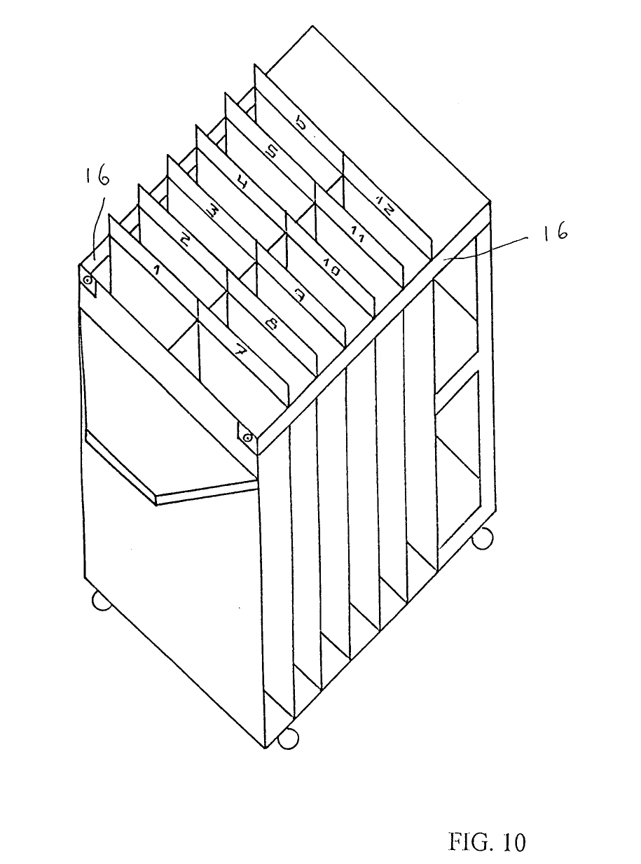

FIG. 10 describes an isometric view of a two-sided apparatus for drawers removable from the side, with a strap 16 which ties and secures the partitions at their upper end.

Nylon Bags and Sacks

It is possible to use nylon bags, or sacks which are inserted into the cells, instead of the drawers.

The bags or the sacks can be attached to the upper part of the partitions, by using appropriate clips, or by using the folding shelf by using its clasp to attach the margins of the bags to the partitions.

Full nylon bags can be replaced with empty bags, the same is possible for full drawers—changing them with empty drawers.

By using these embodiments, the volume of the cells can be reduced, bringing it to the minimal volume required and to maximal usage of the volume for the cells.

Advantages of the Apparatus

Some of the advantages include: the apparatus is small in dimensions therefore it is possible to place it near the working desk. It is convenient to work with. The operator, while being seated, has easy access to all the cells, which are within hand's reach.

It is possible to add to the apparatus other units, which may be similar or different from the first, with cells and drawers of different dimensions, as the need be.

By setting these units around the sorting employee, it is possible to sort the mail while the user sits comfortably on a turning chair, while all the cells are located at a short distance from the sorting employee.

The addresses of the cells are concentrated into a panoramic display, that allows finding every box without effort and in a short time.

The apparatus may save many sorting hours and space, especially expensive wall area, which can be used for office cabinets, or for shelves for storing folders, etc.

It is possible to enlarge the volume of the cells in height and the drawers in length, while the distance between the cells and the sorting employee remains the same.

The drawers can be used as an instrument to transfer the mail to the addressee.

The cells can be narrow and deep, because the mail is sorted to drawers or to the nylon bags, and there is no need to insert the hand into the cells in order to take the mail out.

Manufacturing the Apparatus

The apparatus can be made of stiff plastic or metal, such as stainless steel, aluminum or galvanized iron.

The apparatus can be manufactured from wood or any other stiff material.

Method of Using the Apparatus

The apparatus divides the sorting into three areas:

1. Sorting envelopes to drawers or to sacks, which are within the cells.

2. Sorting papers to the folding shelf, which is attached to drawers, or to the partitions of the cells.

3. Sorting packages and irregular mail on the shelves at the back of the apparatus, according to the order of the cells.

Sorting of the mail may be performed while the sorter is sitting at the front of the apparatus, and the addresses are on the protruding part of the back of the apparatus and on the middle partition between the lines and on the strap that ties the partitions.

The addresses direct the sorter to the appropriate cells.

The apparatus contributes to savings in area and to a better use of the cells' volume.

The apparatus contributes to savings in sorting hours and for the comfort in the sorting work.

An important advantage of the apparatus is in shortening the distance between the cells and the sorting employee—thus, rather than the employee having to reach out to get to the cells, the cells will encircle him, being located at a shorter, more convenient distance.

In summary:

a. The apparatus contributes to saving area, and for a better usage of the volume of the cells.

b. The apparatus contributes to the saving of sorting hours and to the comfort of the employee.

c. An important advantage of the apparatus is in shortening the distance between the cells and the employee. Thus, rather than having the employee reaching out to reach the cells, the cells will encircle him at the shortest distance.

d. The addresses of the cells are concentrated in a conventient location and are presented in a panoramic form, which allows finding each box without an effort and on the shortest time.

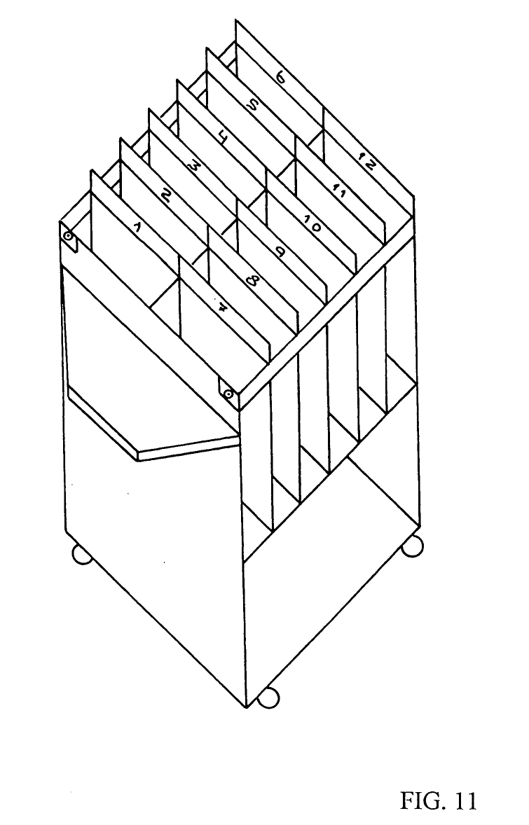

FIG. 11 describes an isometric view of an apparatus, wherein its upper part is dedicated to removable drawers sideways, and its lower part is for packages.

The above description is only one example of an embodiment of the invention. Other implementation possibilities, and additional advantages of the present invention, will become clear to people skilled in the art, upon reading the present description and the drawings.

1. An apparatus for sorting mail, comprising a frame with vertical partitions, a number of removable drawers between the partitions, every drawer having an aperture on its upper part in a manner which allows to insert mail envelopes into the drawers by the sorting employee.

2. The apparatus for sorting mail according to claim 1, further including three sorting areas, one for packages, a second for envelopes and a third for papers.

3. The apparatus for sorting mail according to claim 1, wherein the frame comprises a base, on which a front and vertical partitions are installed in such a way as to create cells between the partitions, and drawers which are inserted into the cells.

4. The apparatus for sorting mail according to claim 1, further including a wide strap at the upper part of the partitions, which ties the partitions.

5. The apparatus for sorting mail according to claim 4, wherein on the wide strap there is a facility for identifying the drawers.

6. The apparatus for sorting mail according to claim 1, wherein the drawers are narrower at their front and wider at their back.

7. The apparatus for sorting mail according to claim 1, further including wheels installed at the bottom of the drawers.

8. The apparatus for sorting mail according to claim 1, wherein the drawer further include means for holding the drawer in order to lift it or to drag it.

9. The apparatus for sorting mail according to claim 8, wherein the facility for holding the drawer includes an aperture at the front of the drawer.

10. The apparatus for sorting mail according to claim 8, wherein the facility for holding the drawer includes an aperture at the back of the drawer.

11. The apparatus for sorting mail according to claim 1, wherein the drawers also include a cover at the upper part of the drawer, in order to allow locking it in place by using a locking hole at the upper part of the drawer.

12. The apparatus for sorting mail according to claim 1, wherein the drawers also include a folding shelf for sorting papers.

13. The apparatus for sorting mail according to claim 1, wherein at the front of the apparatus there is also a horizontal shelf for mail to be placed thereon for sorting.

14. The apparatus for sorting mail according to claim 1, further including horizontal shelves for storing packages.

15. The apparatus for sorting mail according to claim 1, wherein the frame further includes vertical boxes, which are narrow at their front and wider at their back, with removable drawers at the back.

16. The apparatus for sorting mail according to claim 1, wherein the frame includes vertical cells, each cell having a narrow front and a wider back, with partitions for creating cells in one or more rows being installed therebetween, with drawers removable from the top of each cell.

17. The apparatus for sorting mail according to claim 1, wherein the frame includes vertical cells, including a front and a back of about the same size, with parallel partitions being installed therebetween, to create cells in one or more rows, with drawers removable from the upper part of the cells.

18. The apparatus for sorting mail according to claim 17, wherein the rows of cells can either span the length or the width of the apparatus.

19. The apparatus for sorting mail according to claim 1, wherein the frame includes vertical cells, in a two-sided apparatus, with drawers removable from the side.

20. The apparatus for sorting mail according to claim 16, wherein the back of the apparatus and the partitions before it are protruding out, and on them the addresses of the cells are marked.

21. The apparatus for sorting mail according to claim 1, wherein the drawers are narrower at their lower part.

22. The apparatus for sorting mail according to claim 8, wherein the means for holding the drawer in order to lift it includes an aperture at the upper part of the drawer.

23. The apparatus for sorting mail according to claim 1, wherein the frame includes nylon bags inside the cells, which are attached to the partitions with appropriate clips.

24. The apparatus for sorting mail according to claim 1, wherein the frame includes partitions having hooks or clasps installed at their upper part in order to attach sacks whose lower part rests on the base of the apparatus.

25. The apparatus for sorting mail according to claim 1, wherein the apparatus is mounted on wheels.

26. The apparatus for sorting mail according to claim 1, wherein its upper part is dedicated to removable drawers sideways, and its lower part is for packages.
